(19) United States
(12) Patent Application Publication
(10) Pub. No.: US 2012/0080019 A1
(43) Pub. Date: Apr. 5, 2012

(54) TOY PROJECTILE LAUNCHER APPARATUS

(76) Inventor: Robert James Victor, Sunnyvale, NY (US)

(21) Appl. No.: 13/246,186

(22) Filed: Sep. 27, 2011

Related U.S. Application Data
(60) Provisional application No. 61/388,370, filed on Sep. 30, 2010.
(60) Provisional application No. 61/388,383, filed on Sep. 30, 2010.

(51) Int. Cl. F41B 7/08; B23P 17/04

(52) U.S. Cl. 124/16; 29/428

(57) ABSTRACT

A toy projectile launcher apparatus for discharging balls. The apparatus includes a base, a ram movable in the base, a carriage also movable in the base, a negator spring, a handle for cocking the apparatus, a lever pivotally mounted in the base just behind a ball to be discharged and a trigger. In operation a user pulls the handle rearward to cock the apparatus and a catch engages the ram. The carriage is attached to the spring and extends the spring when the carriage and the ram move rearward. The user pulls the trigger to release the ram and the carriage. Before striking the lever, the carriage is stopped and the ram is mounted to the carriage to allow forward sliding movement to enable the ram to impact the lever causing the lever to slap the ball to cause discharge.

### PRIORITY REFERENCE

This application claims priority from Provisional Patent Applications, Nos. 61/388,370 and 61/388,383, both filed on Sep. 30, 2010, which are expressly incorporated herein by reference.

### FIELD OF THE INVENTION

The present invention relates generally to a toy projectile launcher apparatus, and, more particularly, to a toy projectile launcher apparatus that discharges projectiles with good flight characteristics and for long distances.

### SUMMARY OF THE INVENTION

In accordance with the present invention, an advantageous method and apparatus are provided in the form of a toy projectile launcher apparatus that discharges projectiles. The toy launcher is easily operated, even by young children, and requires projectiles to be loaded, a handle to be moved rearward to extend a constant force launch spring, and a rotatable lever to be impacted to cause a projectile, such as a ball, to be discharged. The energy from the launch spring is transferred to the lever that slaps the ball to cause ejection of the ball with a backspin. The launcher apparatus also has the advantages of being relatively simple, fun to use, safe, relatively inexpensive, compact and yet, structurally robust.

Briefly summarized, the invention relates to a toy launcher apparatus for discharging projectiles including a base, a magazine mounted to the base, a cocking assembly mounted to the base, the cocking assembly including a catch, a launch spring connected to the cocking assembly, a lever connected to the base to be rotatable about an axis for transferring energy to a projectile, and a trigger connected to the catch for releasing the launch spring.

The invention also relates to a method for making a toy launcher apparatus capable of discharging projectiles, the steps of the method including providing a base, providing a magazine for storing projectiles, providing a cocking assembly including a ram slidably connected to a ram carriage, providing a constant force launch spring, mounting the magazine and the cocking assembly to the base, connecting the constant force launch spring to the ram, rotatably and laterally mounting a lever to the base positioned to be impacted by the ram to cause the lever to impact a projectile positioned to be discharged, and connecting a trigger to the base to release the ram allowing the ram to be moved by the constant force spring.

### BRIEF DESCRIPTION OF THE DRAWINGS

For the purpose of facilitating an understanding of the invention, the accompanying drawings and detailed description illustrate preferred embodiments thereof, from which the invention, its structures, its construction and operation, its processes, and many related advantages may be readily understood and appreciated.

FIG. 1 is a right side isometric view of a preferred embodiment of the present invention in the form of an unloaded toy projectile launcher apparatus.

FIG. 2 is a right side isometric view of the toy projectile launcher apparatus shown in FIG. 1, but loaded with four balls to be discharged.

FIG. 3 is a reduced side isometric view of the toy projectile launcher apparatus shown in FIGS. 1 and 2, illustrating the launcher apparatus being loaded by a user.

FIG. 4 is a reduced side isometric view of the toy projectile launcher apparatus shown in FIGS. 1-3, in the first half of a cocking cycle.

FIG. 5 is a reduced side isometric view of the toy projectile launcher apparatus shown in FIGS. 1-4, in the second half of a cocking cycle.

FIG. 6 is a diagrammatic side view of a magazine of the launcher apparatus shown in FIGS. 1-5, illustrating three loaded balls.

FIG. 7 is a diagrammatic side view like that shown in FIG. 6, illustrating one of the loaded balls moving into a discharge position.

FIG. 8 is a diagrammatic side view like that shown in FIGS. 6 and 7, illustrating a primary gate blocking two of the loaded balls.

FIG. 9 is a diagrammatic side view like that shown in FIGS. 6-8, illustrating the most forward positioned ball in the discharge position and being restrained by a pressure plate.

FIG. 10 is a diagrammatic side view like that shown in FIGS. 6-9, illustrating the loading of a ball into the magazine.

FIG. 11 is diagrammatic side view like that shown in FIG. 10, illustrating the loading of a second ball into the magazine.

FIG. 12 is diagrammatic side view like that shown in FIGS. 10 and 11, illustrating the primary gate blocking three loaded balls and a fourth ball in the discharge position.

FIG. 13 is a diagrammatic top plan view of the launcher apparatus illustrating the position of a lever and a handle after discharge of a ball.

FIG. 14 is a diagrammatic top plan view of the launcher apparatus shown in FIG. 13, illustrating lever movement during a portion of the first half of a cocking cycle.

FIG. 15 is a diagrammatic top plan view of the launcher apparatus shown in FIGS. 13 and 14, illustrating the position of the lever after being released at the end of the first half of the cocking cycle.

FIG. 16 is a diagrammatic top plan view of the launcher apparatus shown in FIGS. 13-15, illustrating the position of the lever and the handle at the end of the second half of the cocking cycle.

FIG. 17 is a diagrammatic side view of a ram and a ram carriage before the start of the cocking cycle.

FIG. 18 is a diagrammatic side view of the ram and the ram carriage shown in FIG. 17, during the first half of the cocking cycle.

FIG. 19 is a diagrammatic side view of the ram and the ram carriage shown in FIGS. 17 and 18, after release.

FIG. 20 is a diagrammatic side view of the ram shown in FIGS. 17-19, making contact with the lever.

FIG. 21 is a diagrammatic side view of the launcher apparatus as shown in FIGS. 17-20, illustrating the ram transferring energy to the lever and from the lever to a ball.

FIG. 22 is a diagrammatic side view of the ram and the lever shown in FIG. 21, illustrating the ram continuing to transfer energy and the lever inducing a backspin in the ball.

FIG. 23 is a diagrammatic side view of the lever and the ball shown in FIGS. 21 and 22, illustrating a backspin wiper enhancing backspin of the discharging ball.

FIG. 24 is a flow diagram for a method of making the toy projectile launcher apparatus illustrated in FIGS. 1-5.

### DESCRIPTION OF THE PREFERRED EMBODIMENTS

The following description is provided to enable those skilled in the art to make and use the described embodiments set forth in the best mode contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

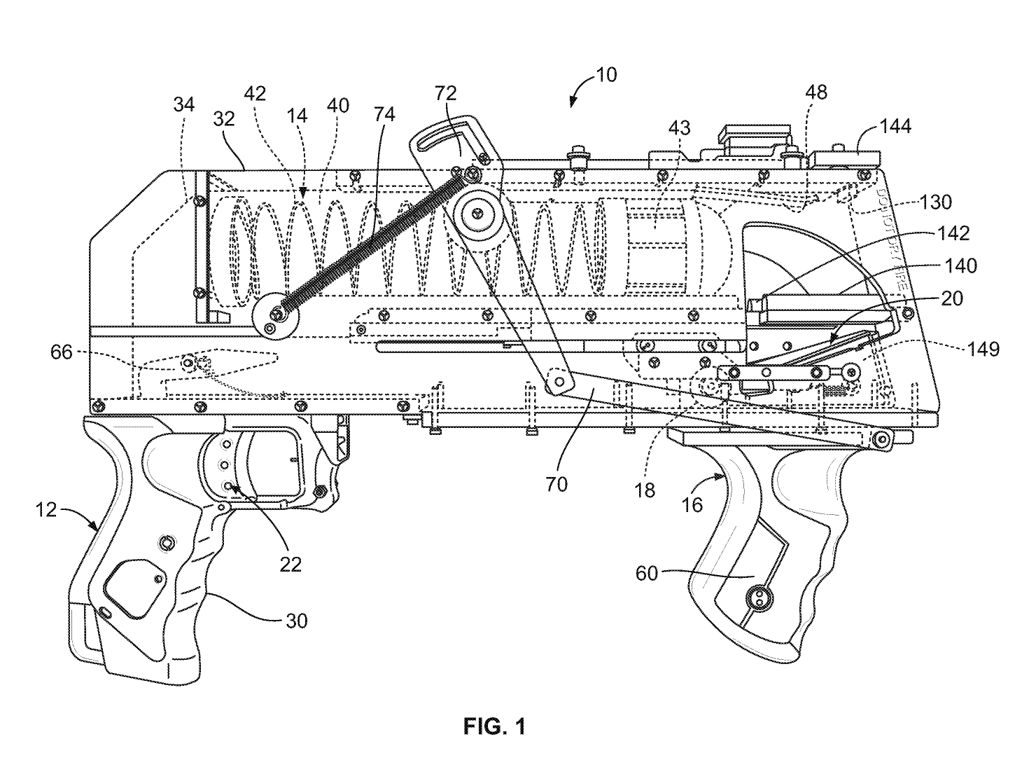

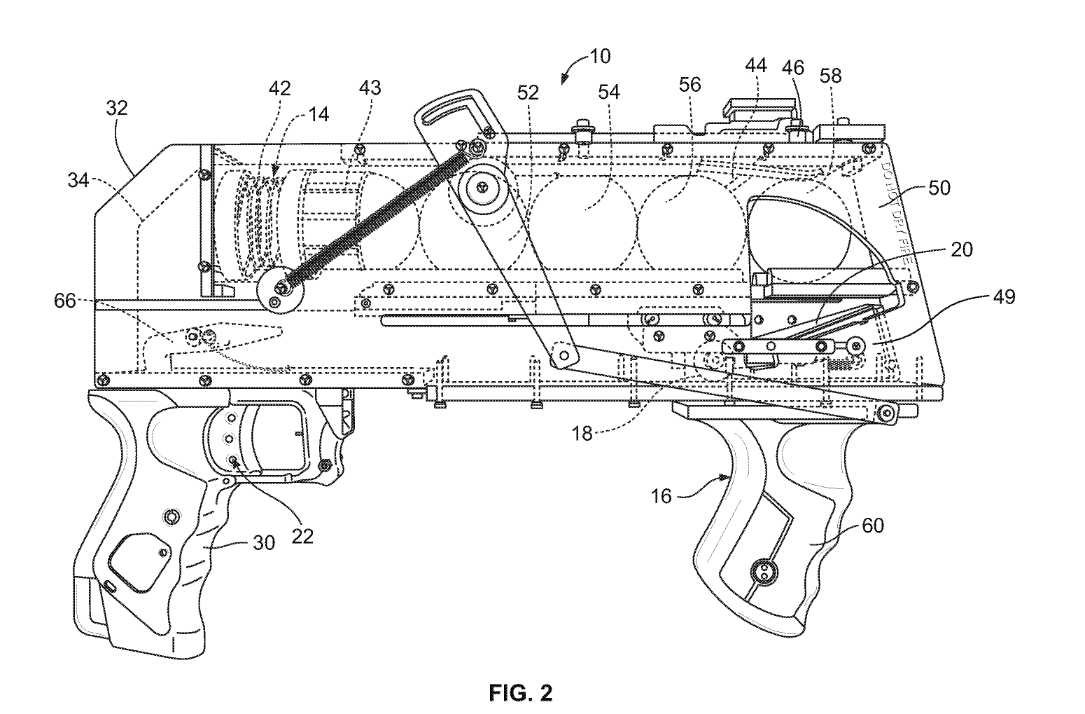

Referring now to FIGS. 1 and 2, there is shown a preferred embodiment of the invention in the form of a toy projectile launcher apparatus 10 for discharging projectiles, such as four loaded balls. The toy launcher apparatus includes a base 12, a magazine 14, a cocking assembly 16, a launch spring 18, a launch lever assembly 20 and a trigger 22. The base 12 includes a grip 30 and side supports 32, 34, the grip enabling a user to hold and aim the toy projectile launcher apparatus while easily loading and cocking the apparatus. The side supports 32, 34 are two spaced apart panels formed of clear plastic to better illustrate internal mechanisms of the launcher apparatus 10. In the alternative, non-clear plastic panels and/or different shapes may be used if found desirable. For example, the base and panels may be replaced by a pump action rifle configuration and the rifle configuration may include designs of a popular merchandising concept such as StarWars, or the design may simulate a real weapon. The cocking assembly 16 is mounted to the base 12 as are the trigger 22, the magazine 14, the launch spring 18, and the launch lever assembly 20.

The magazine 14 includes an elongated chamber 40 that contains a magazine spring 42, a projectile pusher 43, a primary gate 44, a secondary gate 46, a pressure plate 48 and a lever recess 49. The elongated chamber 40 includes an open end 50 through which balls, such as the balls 52, 54, 56, 58, may be loaded and through which each loaded ball is discharged. The primary gate 44 is spring loaded so as to pivot between a lowered or downward position, and a raised or upward position. The secondary gate 46 is also movable between a lowered downward position, and a raised or upward position.

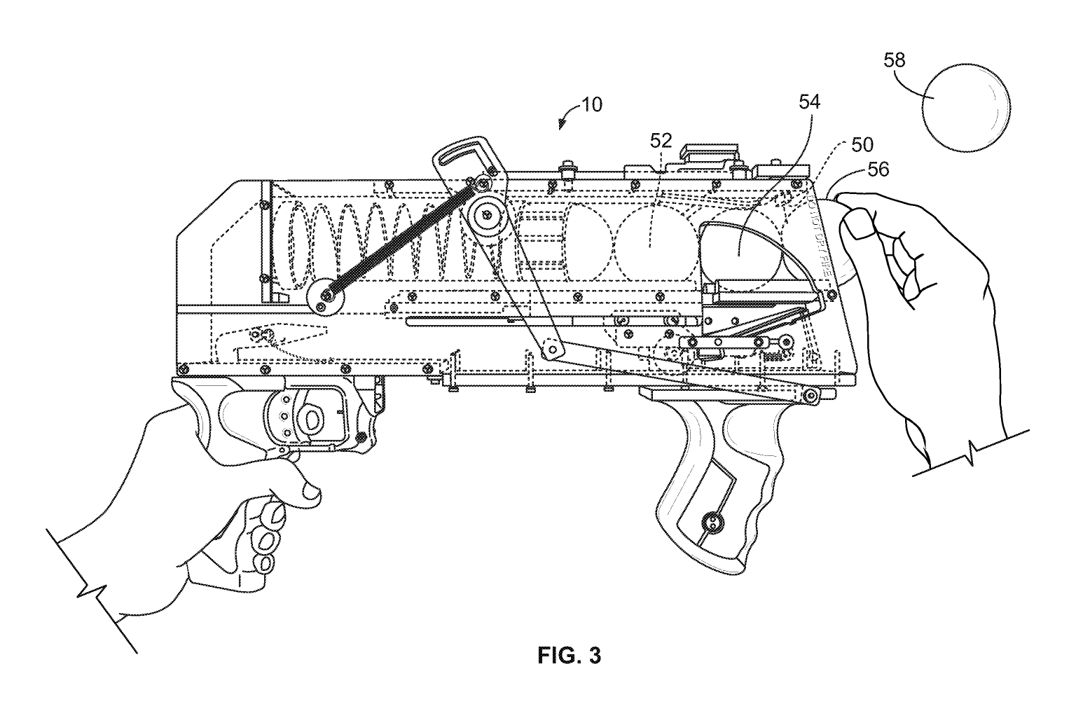

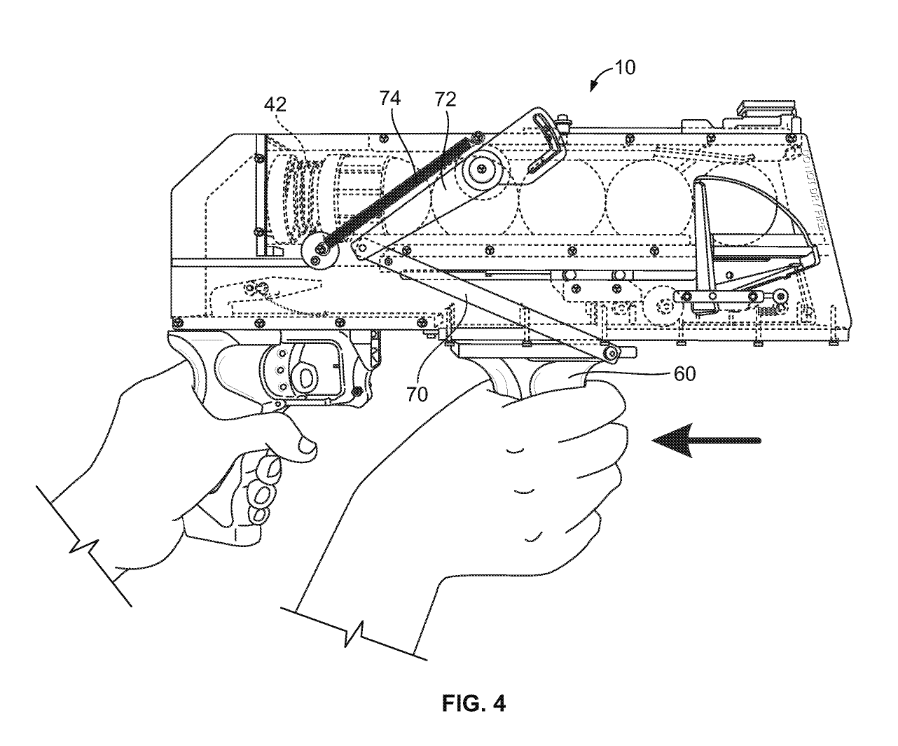

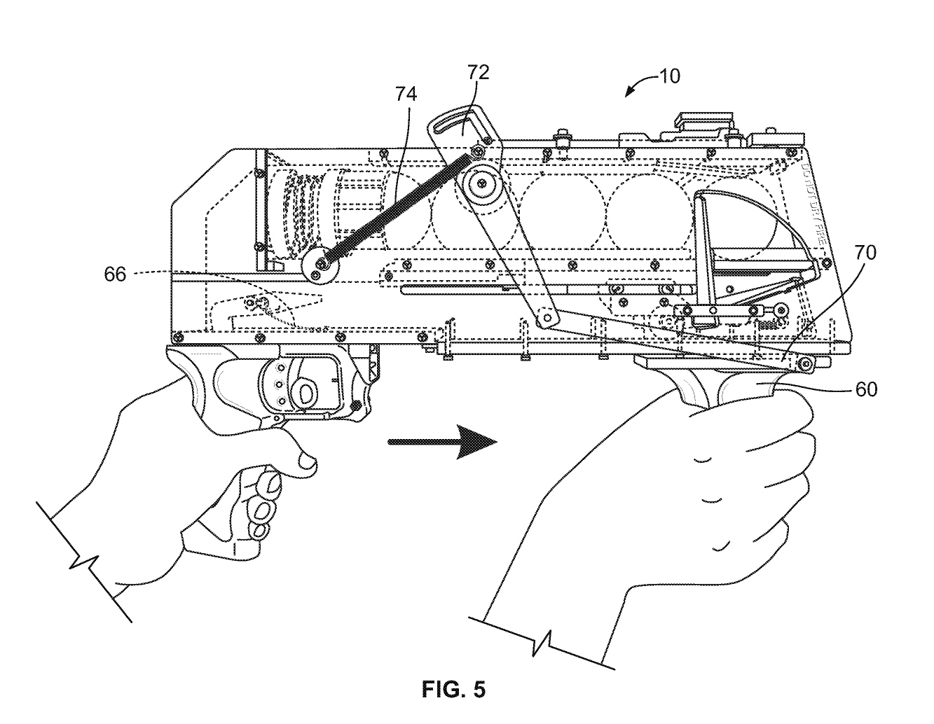

Referring now to FIG. 3, the launcher apparatus 10 is shown being loaded with balls through the open end 50 of the magazine 14. The balls 52, 54 are already loaded and the ball 56 is entering the open end 50. The ball 58 is waiting to be picked up by the user and loaded. Illustrated in FIG. 4, the launcher apparatus 10 is in a half-cocked position, and illustrated in FIG. 5, the launcher apparatus is in a fully cocked position.

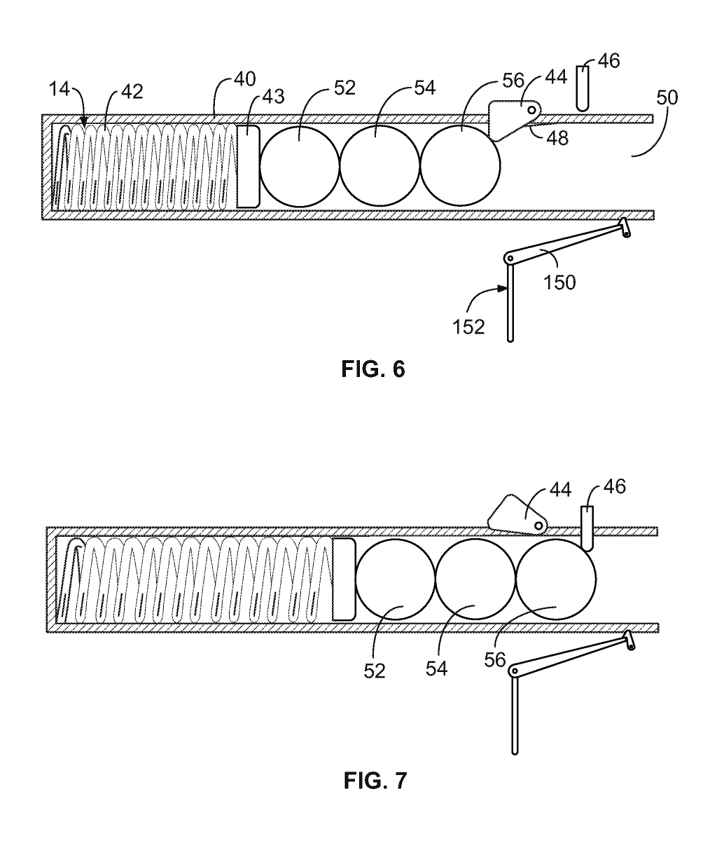

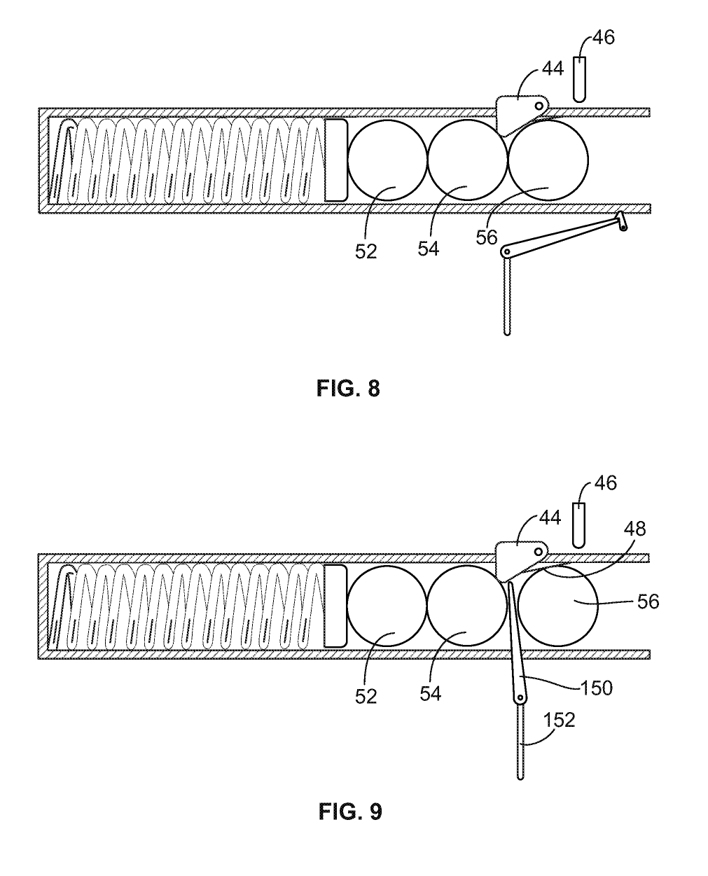

In diagrammatic form the movements of the primary and secondary gates 44, 46 are illustrated in FIGS. 6-9, as are the movement of the balls to a discharge position. Shown in FIG. 6, the magazine is illustrated after the most forward ball is “fired” or discharged from the launcher apparatus, leaving the three balls 52, 54, 56 in the magazine 14. The primary gate 44 is in its downward position to block the three remaining balls from moving forward under the influence of the magazine spring 42 and the pusher 43. The secondary gate 46 is in its upward position. At the beginning of a cocking cycle the primary gate 44, FIG. 7, is raised and the secondary gate 46 is lowered to allow the most forwardly located ball 56 to move forward to the “firing” or discharge position rearward of the secondary gate 46. As the cocking cycle is completed the primary gate 44, FIG. 8, is again lowered to block the loaded balls 52, 54, and the ball 56 is in the discharge position. The secondary gate 46 is raised so that the ball 56 in the discharge position is ready to be ejected. As shown in FIG. 9, the pressure plate 48 restrains the discharge position ball 56. The pressure plate 48 provides a light spring force downward on the ball 56. The pressure plate 48 prevents the most forward located ball from falling out of the launcher apparatus, but engenders only a slight resistance to the ball upon discharge.

The primary and secondary gates 44, 46 are mechanically linked such that the secondary gate 46 reaches its full downward position before the primary gate 44 begins to move upward. Conversely, the primary gate 44 reaches its full downward position before the secondary gate 46 begins to move upward. This arrangement ensures that the stored balls in the magazine are never presented with a clear and unobstructed path out of the launcher apparatus.

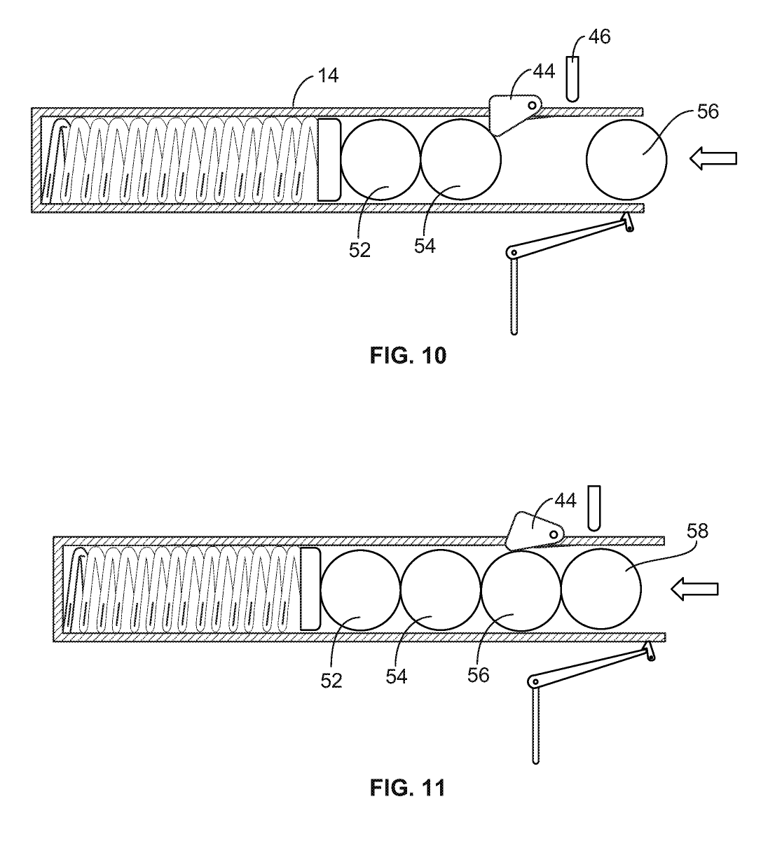

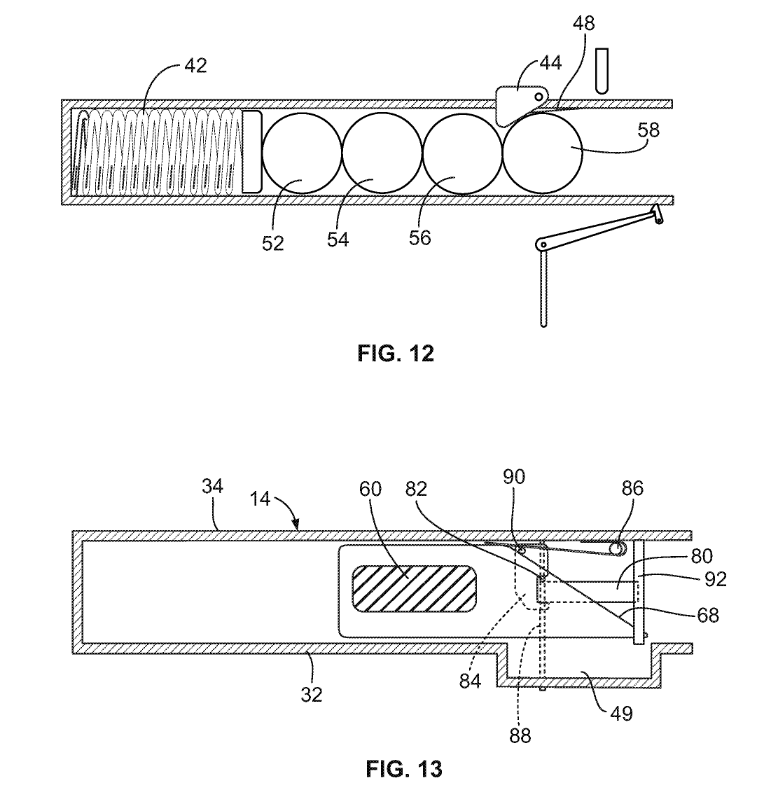

In diagrammatic form the loading of the balls into the magazine 14 is illustrated in FIGS. 10-12, as are the movement of the balls in the magazine. The primary gate 44 insures that as balls are loaded, such as the ball 56, FIG. 10, they are able to move rearward easily because the primary gate 44 is able to rotate. Each newly loaded ball, such as the ball 56, cams the primary gate upward to allow the ball to pass the primary gate, as shown in FIG. 11. However, the primary gate is biased downward as each ball passes so that the balls cannot move forward under the influence of the magazine spring 42 as shown in FIG. 12. Only the last ball 58 is to the right (in the drawing view) of the primary gate and it is being held by the pressure plate 48 in the discharge position ready to be fired.

The launch spring 18 is a constant force spring, also known as a negator spring, and requires approximately a constant five pounds of pull for the negator spring to be extended rearward, a small amount of force that a child can handle easily.

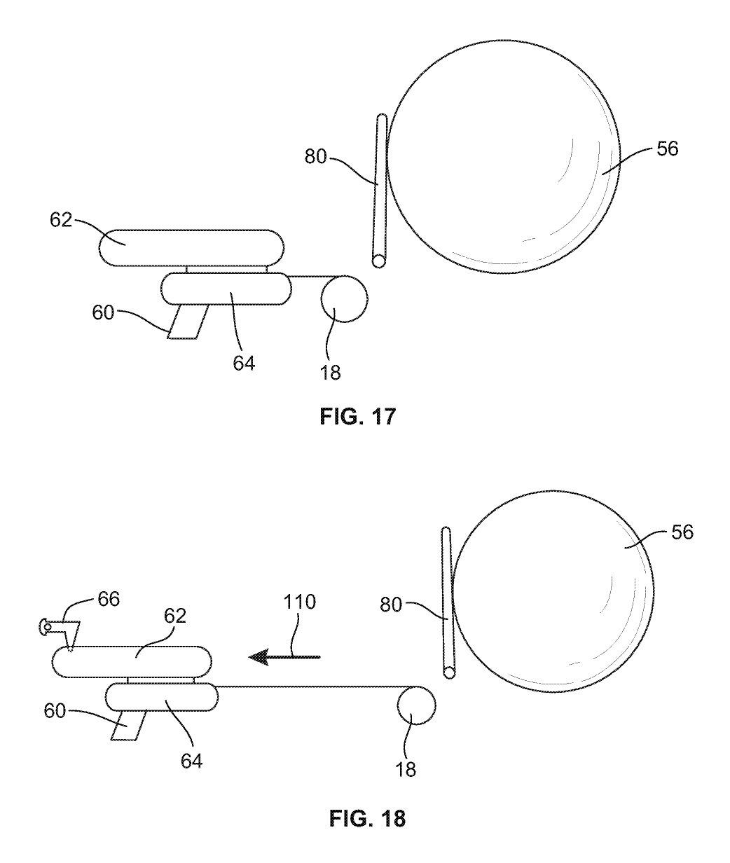

The cocking assembly 16 includes a handle 60, FIG. 1, (and in diagrammatic form, in FIGS. 17-20), a ram 62, FIG. 17, a ram carriage 64, a catch 66, FIG. 18, and a ramp 68, FIG. 13. The handle 60 loads the launch spring 18 as the handle is moved rearward by the user, shown in FIGS. 4 and 18. The rearward movement of the handle 60 extends the launch spring 18 by about four to four and a half inches although in the alternative other extension distances may be desired. When the handle 60 reaches its most rearward position, the combination of the ram 62 and ram carriage 64 is captured by the catch 66, FIGS. 1 and 18. Following the rearward movement, the user moves the handle 60 forward to the handle's initial position as shown in FIG. 5.

The handle 60 is connected to two links 70, 72, FIGS. 1, 4 and 5, and a return spring 74, and these links operate the primary and secondary gates 44, 46. When the handle 60 is moved rearward links 70, 72 cause the secondary gate 46 to be lowered and the primary gate 44 to be raised. This allows a ball to move forward to the discharge position. When the handle 60 is moved forward to the starting position, the links 70, 72 cause the primary gate 44 to be lowered and the secondary gate 46 to be raised, all as explained in relation to FIGS. 6-9.

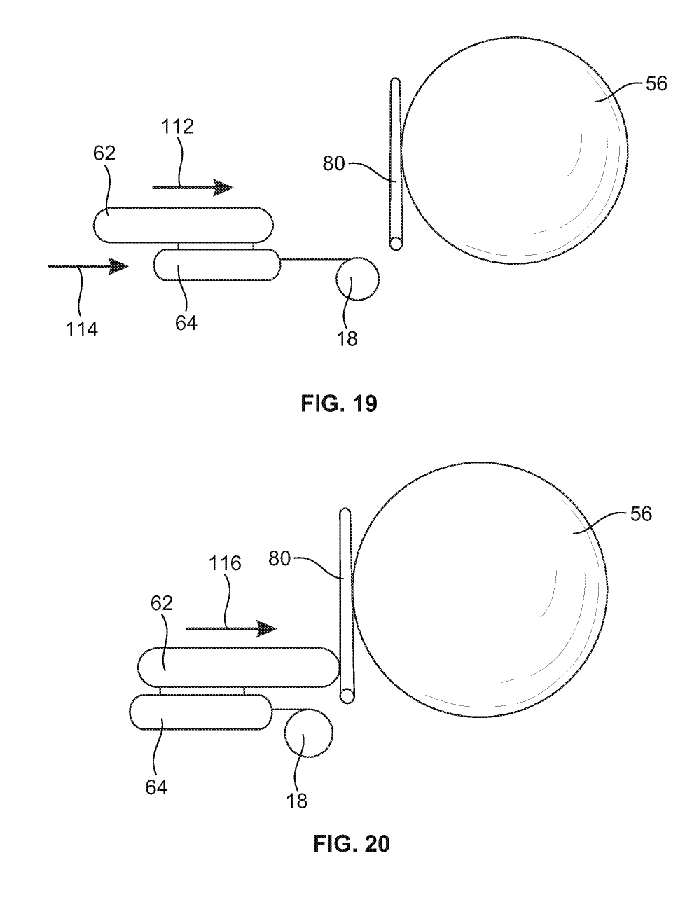

In the preferred embodiment, the handle is pulled rearward about four to four and a half inches for cocking the apparatus. Near the rearward end of the launcher apparatus is the catch 66 which captures the ram 62 and the ram carriage 64 as well as the extended launch spring 18. The ram 62 is slidably connected to the ram carriage 64 such that after being released, the ram carriage 64 will stopped its forward movement before the ram 62, as shown in FIGS. 19 and 20. The ram 62 is able to slide forward another inch to an inch and a half after the ram carriage stops. After the cocking assembly 16 has been retracted about four to four and a half inches, the ram 62 and the ram carriage 64 are in position to be released by the trigger 22 and slide forward under the influence of the biasing force of the launch spring 18. In the preferred embodiment, the launch spring 18 requires about five pounds of pull force to cause extension. The result is approximately a constant five pounds of biasing force acting on the ram 62 and the carriage 64 during the entire forward distance of approximately four to four and a half inches that the carriage travels after release.

A bumper may be included to limit or stop the forward motion of the ram carriage 64 while the ram 62 is able to continue forward, due to momentum, by sliding relative to the carriage for another inch or inch and a half so as to impact a lever as will be explained in more detail below. The ram 62 is made relatively heavy so that there is a greater energy transfer when the ram 62 impacts the lever. The ramp 68 engages the launch lever assembly as will be explained below.

The launch lever assembly 20 includes a lever 80, FIGS. 13-16, a lever return spring 82, a lever carriage 84, a lever carriage return spring 86, a lateral shaft 88, a ramp follower 90 engaged by the ramp 68, and a lever catch 92. The lever in its lowest position occupies the lever recess 49 of the magazine 14. The lever 80, the lever return spring 82 and the ramp follower 90 are mounted to the lever carriage 84 and the lever carriage 84 is mounted to move laterally along the lateral shaft 88. The lever 80 is rotatably mounted to the lever carriage 84 allowing the lever 80 to both rotate, and with the lever carriage, to move laterally (downward in the views of FIGS. 13-16). The lateral shaft 88 is mounted to the side supports 32, 34. The ramp follower 90 is moved along the lateral shaft 88 by the ramp 68 of the cocking assembly 16 as it moves rearward and forward during a cocking cycle, and by the lever carriage return spring 86. The lever catch 92 extends across the magazine 14 and captures the lever in the recess 49 after the lever causes a ball to be discharged.

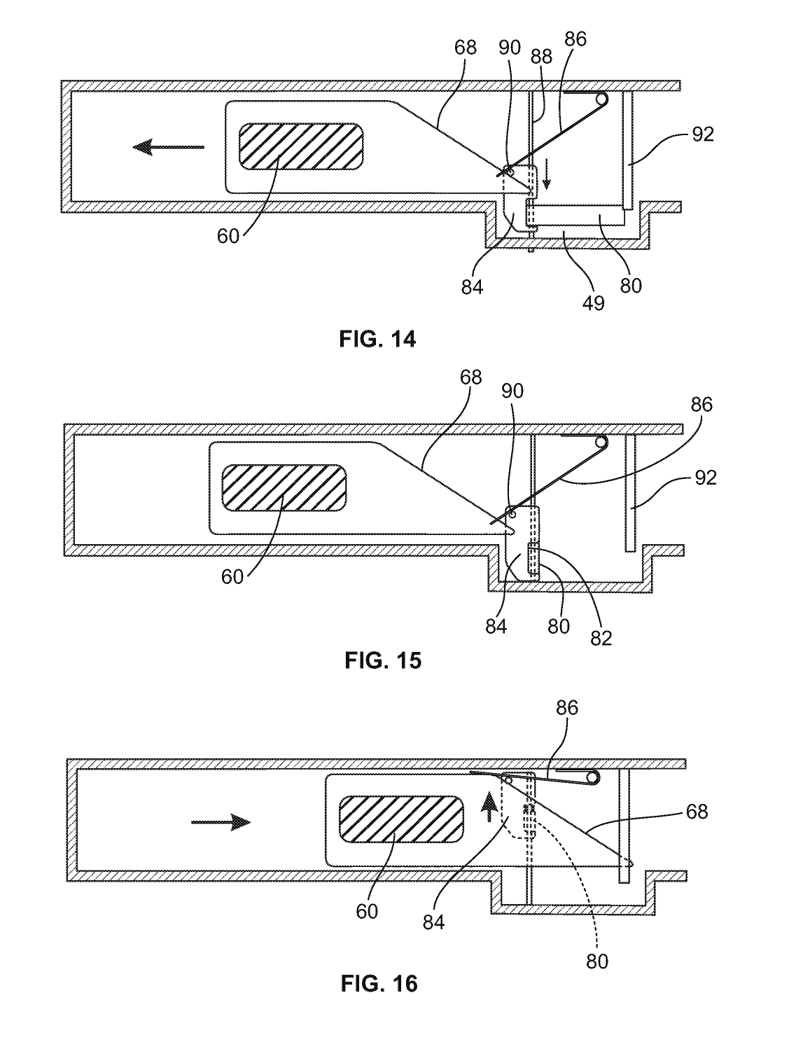

After a ball is discharged, the lever 80, FIG. 13, is centered and captured by the lever catch 92. The ramp 68 is in its forward position so that the ramp follower 90 compresses the lever carriage return spring 86. When the handle 60 begins the cocking cycle and moves rearward, FIG. 14, the ramp 68 moves rearward such that the lever carriage return spring 86 biases the lever carriage 84 to the right (downward in the top plan view of FIG. 14). Before the handle 60 is moved fully rearward, the lever 80 remains captured by the lever catch 92. However, once the launcher apparatus is half cocked, the lever 80 slides from under the lever catch 92. Once released the lever return spring 82 biases the lever to an upright position as illustrated in FIG. 15 (and also shown in FIGS. 17-20). When the handle 60 is moved forward to complete the cocking cycle, the ramp 68, acting as a cam, pushes the ramp follower 90 to the left (upward in FIG. 16) to again center the lever rearward of a ball and the lever carriage return spring 86 is again loaded.

The trigger 22 is connected to the ram and ram carriage catch 66. During the first half of the cocking cycle, the handle 60 moves rearward to extend the launch spring 18 and to have the ram and the ram carriage captured by the catch 66. The handle then returns forward to complete the cocking cycle and place the launcher apparatus in condition to be fired. When the user pulls on the trigger 22, the catch 66 releases the ram 62 and the ram carriage 64 and the launch spring 18 quickly moves the ram to the lever to cause a ball to be discharged.

Referring now to FIGS. 17-23, the operation of the ram 62 and ram carriage 64 is illustrated in detail in diagrammatic form. The structures shown in FIG. 17 include the handle 60, the ram 62, the ram carrier 64, and in FIG. 18, the catch 66. The handle 60 pulls the ram 62 and the ram carrier 64 in a rearward direction, about four to four and a half inches rearward from the start position, until at the end of the first half of the cocking cycle, the ram 62 and the ram carrier 64 are captured by the catch 66 as shown in FIG. 18. The user completes the cocking cycle by moving the handle 60 forward to its start position. As explained above, the cocking cycle extends the launch spring 18, moves a ball to the discharge position and locates the lever 80 behind or rearward of the ball to be discharged. The user releases the ram 62 and the ram carrier 64 by activating the trigger 22, causing them to snap forward under the influence of the launch spring 18, as shown in FIG. 19. When the carrier 64 reaches its starting position it stops and the ram 62 is able to continue forward by sliding relative to the ram carrier. The ram continues forward about another inch or inch and a half and impacts the lever 80 which transfers the energy from the heavy and fast moving ram 62 to the ball 56 as shown in FIG. 20.

Referring back to FIG. 17, the launcher apparatus is represented in a starting position with a loaded ball. Next, a user pulls the handle 60 rearward as represented by an arrow 110, FIG. 18. Along with the handle 60, the connected ram 62 and the ram carriage 64 are also moved rearward and the launch spring 18 is extended rearward thereby loading the launch spring. After about a four to four and a half inch extension of the launch spring, the ram and the ram carriage combination are captured by the catch 66 as also shown in FIG. 18. The handle then returns to its forward position. When the trigger rotates the catch 66 to release the ram 62 and the ram carriage 64 they are able to accelerate forward. After release, the ram 62 and the ram carriage 64 move forward together as represented by the arrows 112, 114 under the influence of the launch spring toward the lever 80 as shown in FIG. 19. The ram carriage 64 moves forward to its start position and/or until impact with a bumper (not shown). The ram 62, however, which is slidable relative to the ram carriage, is able to continue forward motion for another inch or inch and a half as shown in FIG. 20 and as represented by the arrow 116. By sliding forward on its own, the relatively heavy and fast moving ram 62 is able to transfer increased energy to the lever 80.

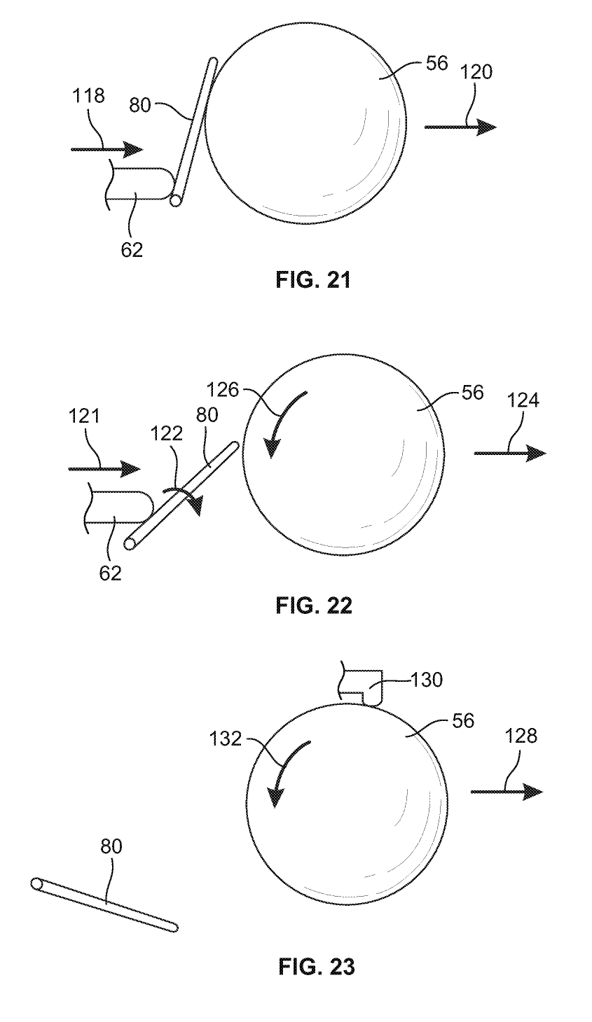

The ram impacts the lever 80 at a location about the lower third of the lever and continues to impart energy as the ram 62 moves forward as indicated by the arrow 118. The impact engenders a force multiplier effect as the lever 80 slaps or smacks into the ball 56, as shown in FIG. 21, accelerating the ball to the right in the drawing, represented by the arrow 120. Energy transfer from the ram 62 to the lever 80 and then to the ball 56 starts on impact of the ram with the lever and continues as the ram moves forward (depicted by the arrow 121, FIG. 22). The lever rotates clockwise represented by the arrow 122. The ball 56 moves to the right as shown by an arrow 124. The downward motion of the rotating lever also imparts a counterclockwise spin in the ball as indicated by an arrow 126, in addition to an ejection force to the right. After the ball 56 separates from the lever 80 and moves in the direction of the arrow 128, the ball passes and lightly contacts a backspin protrusion or wiper 130, FIG. 23, to enhance the counterclockwise spin of the ball as shown by the arrow 132, because a frictional force component is engendered on the ball. The launch lever 80 continues to rotate clockwise into the recess 49, FIG. 1, between two rails 140, 142, until the lever return spring 82 stops the rotation of the lever.

The backspin protrusion or wiper 130 is attached to a top panel 144 mounted to the side supports 32, 34 and is positioned to cause the ball to be slightly squeeze as discharge occurs. A friction force is generated in a rearward direction thereby causing the ball to increase its rearward rotation or backspin. Having a backspin enables the ball to travel a great distance with a relatively small amount of energy transfer.

It is noted that throughout this disclosure, words such as “forward”, “rearward”, “upper”, “lower”, “front”, and “rear”, as well as like terms, refer to portions of the toy launcher apparatus as they are viewed in the drawings relative to other portions or in relationship to the positions of the apparatus as it will typically be held and moved during play when operated by a user.

In the alternative, the ram and the ram carriage may be deleted and the handle may be made heavier and attached directly to the launch spring to operate like a slingshot. Other projectile shapes may be used in place of spherical-shaped projectiles. Size and dimensions may change to extend the travel of the handle to more than about four to four and a half inches and/or the launch spring may have a pull of more than about five pounds. The launcher apparatus may include, in the alternative, a cartridge, a cassette or a canister loaded with multiple projectiles. As another alternative, instead of the lever assembly shown in FIGS. 13-16, a lever 150, FIGS. 6-9, may be used. The lever 150 is rotatable and movable vertically in a slot 152 instead of the lateral movement along the shaft 88. Also, it should be noted that the various structures described above which have been grouped as part of an assembly, may be treated individually without regard to an “assembly”, or the structures may be grouped in smaller assemblies or subassemblies. The use of an assembly here is strictly for convenience and clarity.

In operation of the launcher apparatus, after discharge of a ball, one or more balls may be loaded into the magazine through the magazine's open end. The primary gate pivots and allows the balls to be loaded, but the primary gate, when lowered, does not move forward. When the user initiates a cocking cycle by moving the handle rearward, the ram and the ram carriage are moved rearward and the constant force spring is extended until the catch captures the ram and the ram carriage. At the same time the secondary gate is lowered and the primary gate is raised to allow the forward-most ball to move further forward and position itself against the secondary gate. Also at the same time, the lever is moved laterally rightward to escape the lever catch and to rotate upward. The cocking cycle is continued when the handle is moved forward so that the primary gate is lowered and the secondary gate is raised to block all of the loaded balls except for the ball to be discharged. The ball to be discharged has an unobstructed exit from the magazine except that it is lightly held in place by the pressure plate. At the same time, as the handle moves forward, the ramp moves the lever and lever carriage to a centered position rearward of the ball to be discharged. Thereafter, the user may cause the ball to be fired by pulling on the trigger so that the ram and the ram carriage are released from the catch and are accelerated by the launch spring in the forward direction. The impact of the ram with the lever causes the ball to discharge with a backspin. Backspin is further enhanced on the discharging ball by having the ball brush past the wiper.

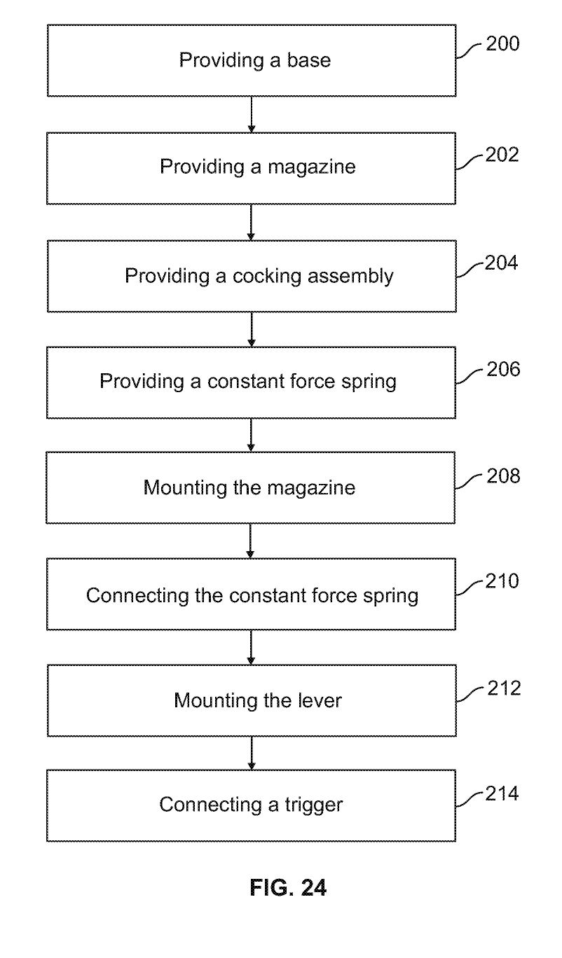

The present invention also includes a method for making the toy launcher apparatus 10, the steps including providing 200, FIG. 24, a base, providing 202 a magazine for storing projectiles, providing 204 a cocking assembly including a ram slidably connected to a ram carriage, providing 206 a constant force launch spring, mounting 208 the magazine and the cocking assembly to the base, connecting 210 the constant force launch spring to the ram, rotatably and laterally mounting 212 a lever to the base positioned to be impacted by the ram to cause the lever to impact a projectile to be discharged, and connecting 214 a trigger to the base to release the ram to allow the ram to be moved by the constant force spring.

The toy launcher apparatus disclosed in detail above has great play value, is fun to use and easy to operate in a safe manner, even for young children, and yet the launcher apparatus has a robust, but simple structure, that may be produced at a reasonable cost.

From the foregoing, it can be seen that there has been provided features for an improved toy launcher apparatus and a disclosure for the method of the making the toy. While particular embodiments of the present invention have been shown and described in detail, it will be obvious to those skilled in the art that changes and modifications may be made without departing from the invention in its broader aspects. Therefore, the aim is to cover all such changes and modifications as fall within the true spirit and scope of the invention. The matters set forth in the foregoing description and accompanying drawings are offered by way of illustrations only and not as limitations. The actual scope of the invention is to be defined by the subsequent claims when viewed in their proper perspective based on the prior art.

What is claimed is:

1. A toy launcher apparatus for discharging projectiles comprising:
a base;
a magazine mounted to the base;
a cocking assembly mounted to the base including a catch;
a launch spring connected to the cocking assembly;
a lever connected to the base to be rotatable about an axis for transferring energy to a projectile; and
a trigger connected to the catch for releasing the launch spring.

2. The toy launcher apparatus of claim 1 wherein:
the cocking assembly includes a ram and a ram carriage connected to the launch spring, the ram being slidably connected to the ram carriage.

3. The toy launcher apparatus of claim 1, wherein:
the base includes a support structure; and including
a backspin protrusion mounted to the support structure in the path of a discharging projectile.

4. The toy launcher apparatus of claim 1, wherein:
the launch spring is a constant force spring.

5. The toy launcher apparatus of claim 1, including:
a lever return spring mounted to the lever for rotating the lever to an upright position.

6. The toy launcher apparatus of claim 1, wherein:
the magazine includes a primary gate, a secondary gate and a pressure plate.

7. The toy launcher apparatus of claim 1, wherein:
the lever is moveable laterally along the axis.

8. The toy launcher apparatus of claim 1, wherein:
the cocking assembly includes a ram and a ram carriage connected to the launch spring, the ram being slidably connected to the ram carriage; and
the magazine includes a primary gate, a secondary gate and a pressure plate.

9. The toy launcher apparatus of claim 8, wherein:
the launch spring is a constant force spring.

10. A method for making a toy launcher apparatus capable of discharging projectiles, the steps of the method comprising:
providing a base;
providing a magazine for storing projectiles;
providing a cocking assembly including a ram slidably connected to a ram carriage;
providing a constant force launch spring;
mounting the magazine and the cocking assembly to the base;
connecting the constant force launch spring to the ram;
rotatably and laterally mounting a lever to the base positioned to be impacted by the ram to cause the lever to impact a projectile to be discharged; and
connecting a trigger to the base to release the ram allowing the ram to be moved by the constant force spring.
